(19) United States
(12) Patent Application Publication
(10) Pub. No.: US 2008/0258120 A1
(43) Pub. Date: Oct. 23, 2008

(54) Water pressure transfer film and method utilizing the same

(75) Inventor: Ching-Chang Yang, Taoyuan County (TW)

Correspondence Address: Joe McKinney Muncy, PO Box 1364, Fairfax, VA, 22038-1364, US

(73) Assignee: Taiwan Decor Technology Co., Ltd.

(21) Appl. No.: 11/976,056

(22) Filed: Oct. 19, 2007

(30) Foreign Application Priority Data
Apr. 19, 2007 (TW) 96113778

(51) Int. Cl. G03C 1/00; B05D 3/00; B05D 3/06

(52) U.S. Cl. 252/600; 427/532; 427/558

(57) ABSTRACT

Disclosed are water pressure transfer films and methods utilizing the same. The film includes a carrier layer which is soluble or swells in water, a protective layer composed of a dual-curable composition, and a decorating layer. After transferring on an object surface, the protective layer is cured by UV radiation, the carrier layer is washed out, and the protective layer is then further cured by a thermal source. Alternatively, the protective layer can be first cured by a thermal source and further cured by UV radiation. The decorating layer includes printing ink pattern, embossed surface relief hologram pattern, or combinations thereof. The active agent of the water pressure transfer film is also a dual-curable composition.

### BACKGROUND OF THE INVENTION

1. Field of the Invention

The invention relates to water pressure transfer, and in particular to water pressure transfer films and method utilizing the same.

2. Description of the Related Art

In the conventional water pressure transfer method, a pattern is printed on a carrier layer and the ink of the printing pattern is activated by coating an active agent. An object is pressed into a water tank to contact the activated printing pattern, thereby transferring the pattern to the object's surface. The water soluble carrier layer is then washed out, the object is dried, and a prime is coated on the object's surface to act as an additional protective layer. This method produces a great amount of volatile organic compound (VOC) when coating the prime, and consumes considerable energy when heat curing the prime. Accordingly, this method is not environmental friendly. This method also includes risks of process error and dust adhesion, thereby reducing the method's economic value.

Taiwan Patent Publication No. 200402332 disclosed a water pressure transfer film including a carrier layer, a protective layer, and a printing pattern layer. Because the protective layer, composed of UV curable composition, and the printing pattern layer can be completed simultaneously, the process is shortened and environmental friendly in theory. The active agent used to active the film in this Publication is general solvent; however, the protective layer containing solvent is still covered by the carrier layer after water press transfer. Due to wash out the remaining carrier layer and vaporization of remaining active agents (solvent), protective layer defects such as orange peel and/or crater due to strain effect may occur. Meanwhile, the carrier layer is washed out after water press transfer, and the protective layer is then cured by UV radiation. Because the activated protective layer is swelled by solvent and still soft, the process of washing out the carrier layer results in protective layer defects.

Taiwan Patent Publication No. 200512101 provides a modified water pressure transfer film which avoids the shortcomings in Publication '332, such as active agent solvent and curing and washing process order. The film of Publication '101 includes a carrier layer, a protective layer, and a printing pattern layer. The protective layer, the printing pattern layer, and an active agent applied to active the film are all UV-curable composition. Because the protective layer, the printing pattern layer, and the active agent are UV cured, it prevents the problem caused from organic solvent residue. In addition, the protective layer is cured after water press transfer and the swelling transfer layer is washed out, thereby preventing protective layer defects. However, the modified patent still results in other shortcomings. For example, the printing pattern often includes opaque ink, such that the protective layer, printing pattern, and the active agent cannot be completely cured by UV radiation. In addition, if the object has a curved surface, the protective layer, the printing pattern, and the active agent in the dead angle (e.g. shadowed part) is not completely cured by UV radiation. The uncured areas of the protective layer, the printing pattern, and the active agent have a rough and uneven surface and can even peel in extreme conditions. Therefore, a novel water press transfer film and corresponding method is called for, which solves the above stated undesired effects.

### SUMMARY OF THE INVENTION

The invention provides a water pressure transfer film comprising a carrier layer and a protective layer, wherein the protective layer is a first radiation-thermal dual curable composition.

The invention also provides a water pressure transfer method, comprising providing an active agent to activate the described film, wherein the protective layer is swelled by active agent and the characters are as mutually miscible, wherein the active agent is a second radiation-thermal dual curable composition. The activation step comprises coating the active agent to the film and then floating the film on the water, or floating the film on the water and then coating the active agent to the film. The method further places an object on the film by pressing the object and the film into water, such that the film wraps the object, taking the object out of water, providing a radiation to cure the well swelled mixture of the protective layer and the active agent, washing out the carrier layer, and providing a thermal source to further cure the well swelled mixture of the protective layer and the active agent.

The invention also provides a water pressure transfer method, comprising providing an active agent to activate the described film, wherein the active agent and the protective layer are swelled, wherein the active agent is a second radiation-thermal dual curable composition. The activation step comprises coating the active agent to the film and then floating the film on the water, or floating the film on the water and then coating the active agent to the film. The method further places an object on the film by pressing the object and the film into water, such that the film wraps the object, taking the object out of water, providing a thermal source to cure the well swelled mixture of the protective layer and the active agent, washing out the carrier layer, and providing a radiation to further cure the well swelled mixture of the protective layer and the active agent.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A-1E show sequential section views of a water press transfer method utilizing water transfer films in an embodiment of the invention; and

FIGS. 2A-2C show sequential section views of a water press transfer method utilizing a water transfer film in another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

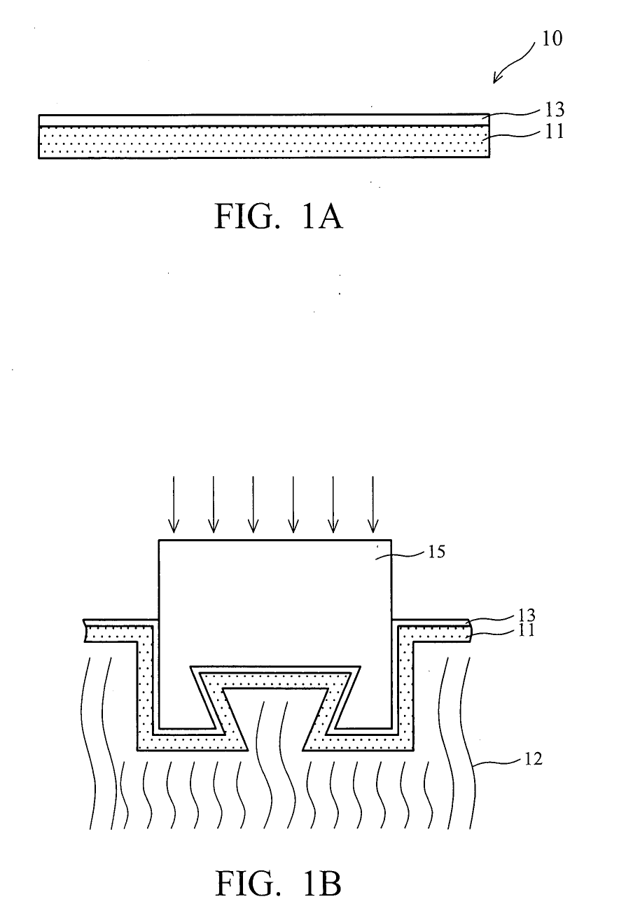

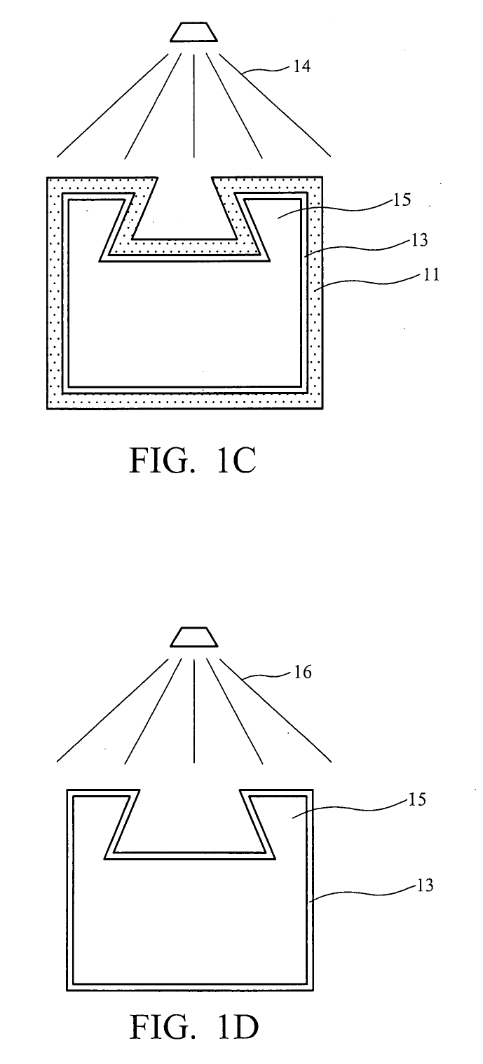

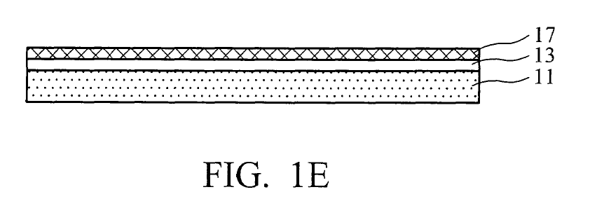

For solving undesired effects due to using opaque ink in the printing pattern or multiple steps for curing due to dead angles (or shadows), the invention provides a water pressure transfer film and a method utilizing the same. As shown in FIG. 1A, the water press transfer film 10 includes a carrier layer 11 and a protective layer 13. The water press transfer film 10 is applied to wrap the object; especially curved surface objects. Sequentially as shown in FIG. 1B, the water press transfer film 10 is activated by an active agent. The protective layer 13 is well swelled by the active agent. The activation process can be by coating the active agent to the water press transfer film 10 and then floating the water press transfer film 10 on the water, or by floating the water press transfer film 10 on the water and then coating the active agent to the film 10. After the active agent is well swelled into the protective layer 13, the curved surface object 15 is placed on the water press transfer film 10 and pressed into the water, such that the water press transfer film 10 evenly wraps the object 15 by water pressure. The carrier layer 11 adsorbs water to be swelled and slowly dissolved. In an embodiment of the invention, the carrier layer 11 is an water soluble polymer such as polyvinyl alcohol (hereinafter PVA), polyvinylpyrrolidone, acetyl cellulose, polypropylene amide, acetylbutyl cellulose, gelatin, bone flue, sodium alginate, hydroxyl ethyl cellulose, carboxyl methyl cellulose, and the likes.

The object 15 is wrapped by the film 10 and then taken from the water. As shown in FIG. 1C, the curved surface of the object 15 faces up and a radiation 14 is applied to irradiate the curved surface, such that the well swelled mixture of the protective layer 13 and the active agent is initially cured. Thus, allowing the following wash step of removing the carrier layer 11 to not damage the protective layer 13.

Both of the protective layer 13 and the active agent are radiation-thermal dual curable composition. The curing step order includes initially curing by radiation and then curing by a thermal source, or initially curing by a thermal source and then curing by radiation. The radiation-thermal dual curable composition comprises photo initiator, thermal initiator, oligomer, monomer, and membrane resin. In an embodiment of the invention, the protective layer 13 has 20 wt % to 70 wt % of resin, 10 wt % to 50 wt % of oligomer, 14 wt % to 29.8 wt % of monomer, 0.1 wt % to 3 wt % photo initiator, and 0.1 wt % to 3 wt % thermal initiator. In an embodiment of the invention, the active agent includes 5 wt % to 10 wt % of resin, 10 wt % to 20 wt % of oligomer, 60 wt % to 84.8 wt % of monomer, 0.1 wt % to 5 wt % photo initiator, and 0.1 wt % to 5 wt % thermal initiator. Applying a radiation or thermal source to the swelled mixture of the protective layer 13 and the active agent, free radicals or cations are formed from a photo initiator or a thermal initiator, respectively. The oligomer, monomer, and the membrane resins are polymerized and cured by the free radicals and cations. The radiation can be UV radiation, electron beam, or combinations thereof. For example, the UV radiation has irradiation intensity of about 0.0004 watts/cm² to 100 watts/cm², wavelength of about 250 nm to 400 nm, and irradiation time of about one second to one minute. The thermal source can be infrared radiation, hot air oven, or combinations thereof. The thermal source has a temperature of about 55° C. to 150° C. and heating time of about 10 second to 30 minutes.

The described monomer serves as solvent to dissolve the oligomer and the solution can be coated on the protective layer 13. The monomer can be polymerized with the photo initiator and the oligomer after irradiated, thereby preventing solvent residue. The membrane resin includes thermoplastic and thermosetting resins. In an embodiment of the invention, the thermoplastic resin can include alkyd resin, acrylic resin, polyurethane resin, amino resin, carbamide resin, epoxy resin, polyester resin, vinyl resins such as dichlorovinyl resin or difluorovinyl resin, ethylene-vinyl acetate resin, polyolefin resin, chloro polyolefin resin, vinyl acrylic resin, petroleum resin, or cellulose derivative resin. The alkyd resin, acrylic resin, polyurethane resin, cellulose derivative resin, and ethylene-vinyl acetate resin are more preferable. Thermosetting resin includes at least two reactive functional groups for crosslinking. The functional groups can be N-methylol, N-alkoxymethyl, amino, hydroxyl, isocyanate, carboxyl, epoxy, methoxy, carboxyl anhydride, or ethylene. In an embodiment of the invention, the oligomer and the monomer can include the described reactive functional groups such as epoxy acrylic ester, urethane acrylic ester, ester acrylic ester, ether acrylic ester, acrylic-acrylic resin, unsaturated resin, or monomer/oligomer or at least one acrylic ester functional group.

The radiation type, wavelength, and energy intensity are determined by photo initiator. The photo initiator includes acetophenones such as 2-methyl-1-(4-(methylthio)phenyl)-2-morpholino-propane, 1-hydroxycyclohexyl phenyl ketone, diethoxyacetophenone, 2-hydroxy-2-methyl-1-phenyl-propane-1-one, 2-benzyl-2-(dimethylamino)-1-[4-(morpholinyl)phenyl]-1-butanone, or other suitable acetophenones. The photo initiator also includes benzoins such as benzoin methyl ether, benzyl dimethyl ketal, or other suitable benzoins. The photo initiator further includes benzophenones such as 4-phenyl benzophenone, hydroxyl benzohenone, or other suitable benzophenones. The photo initiator includes thioxanthones such as isopropyl thioxanthone, 2-chlorothioxanthone, or other suitable thioxanthones. The photo initiator also includes anthraquinones such as 2-ethylanthraquinone, or the likes. The described photo initiator can be used individually, or collectively to obtain higher photosensitivity. For example, the photo initiator combination can be isopropyl thioxanthone mixed with 2-benzyl-2-(dimethylamino)-1-[4-(morpholinyl)phenyl]-1-butanone.

The thermal initiator has a decomposition temperature of about 55° C. to 150° C. The thermal initiator can be azo compound such as 2,2′-azobis(2,4-dimethyl valeronitrile), dimethyl 2,2′-azobis(2-methylpropionate), 2,2-azobisisobutyronitrile (hereinafter AIBN), 2,2-azobis(2-methylisobutyronitrile), 1,1′-azobis(cyclohexane-1-carbonitrile), 2,2′-azobis[N-(2-prophenyl)-2-methylpropionamide], 1-[(cyano-1-methylethyl)azo]formamide, 2,2′-azobis(N-butyl-2-methyl propionamide), 2,2′-azobis(N-cyclohexyl-2-methylpropionamide), or other suitable azo compounds. The thermal initiator also includes peroxide such as benzoyl peroxide, 1,1-bis(tert-butylperoxyl)cyclohexane, 2,5-bis(tert-butylperoxy)-2,5-dimethylcyclohexane, 2,5-bis(tert-butylperoxy)-2,5-dimethyl-3-cyclohexyne, bis(1-tert-butylperoxy)-1-methyl-ethyl)benzene, tert-butyl hydroperoxide, tert-butyl peroxide, tert-butyl perperoxybenzoate, cumene hydroperoxide, cyclohexanone peroxide, dicumyl peroxide, lauroyl peroxide, or other suitable peroxides. The described thermal initiator can be used individually or collectively if necessary.

As shown in FIG. 1C, the object 15 has an indentation. The protective layer 13 in the indentation cannot be cured by radiation. After washing out the remaining carrier layer 11, the mixture of the protective layer 13 and the active agent is heated by thermal source 16 to prevent uneven curing, as shown in FIG. 1D. The thermal initiator of the mixture of the protective layer 13 and the active agent will decompose to form radical or cation by heating, such that the oligomer and the monomer of the mixture further polymerizes. Preferably thermal source 16 can be infrared radiation, hot air oven, or combinations thereof. The heating step is to insure that the mixture of the active agent and the protective layer 13 disposed in the indentation or a dead angle, not irradiated by the radiation as shown in FIG. 1C, can be polymerized to cure. Because the step of washing out the carrier layer requires a dry bake step to remove residue water, the heating process of additional curing is free of additional equipment cost. Accordingly, the invention solves the undesired effects of multiple steps for curing due to dead angles (or shadows). The invention also solves the undesired effects such as incomplete curing due to a thicker protective layer or using opaque ink in the printing pattern.

In another embodiment of the invention, a decorating layer 17 is added on the protective layer 13 as shown in FIG. 1E. The decorating layer 17 can be a printing ink pattern, an embossed surface relief hologram pattern, or combinations thereof. The printing ink pattern, composed of solvent-based ink or water-based ink, is printed on the protective layer 13. The embossed surface relief hologram pattern can be printed, evaporated, or sputtered to be formed on the protective layer 13, composed of metal, metal compound, or polymer resins. The metal includes Be, Mg, Ca, Sr, Ba, La, Ce, Cr, Mn, Cu, Ag, Au, Al, Sb, Pd, or Ni. The metal compound includes Sb₂S₃, Fe₂O₃, PbO, ZnSe, CdS, Bi₂O₃, TiO₂, PbCl₂, CeO₂, Ta₂O₅, ZnS, ZnO, CdO, Nd₂O₃, Sb₂O₃, ZrO₂, WO₃, Pr₆O₁₁, SiO, In₂O₃, Y₂O₃, TiO, ThO₂, Si₂O₃, PbF₂, Cd₂O₃, La₂O₃, MgO, Al₂O₃, LaF₃, CeF₃, NdF₃, ThF₄, and the likes. The polymer resin can be poly tetrafluoroethylene, poly chlorotrifluoroethylene, acetic acid vinyl ester resin, polyethylene, polypropylene, methyl methacrylate resin, nylon, polystyrene, poly dichloroethylene resin, polyvinyl formal resin, polyvinylchloride, poly ester resin, or novolac resin.

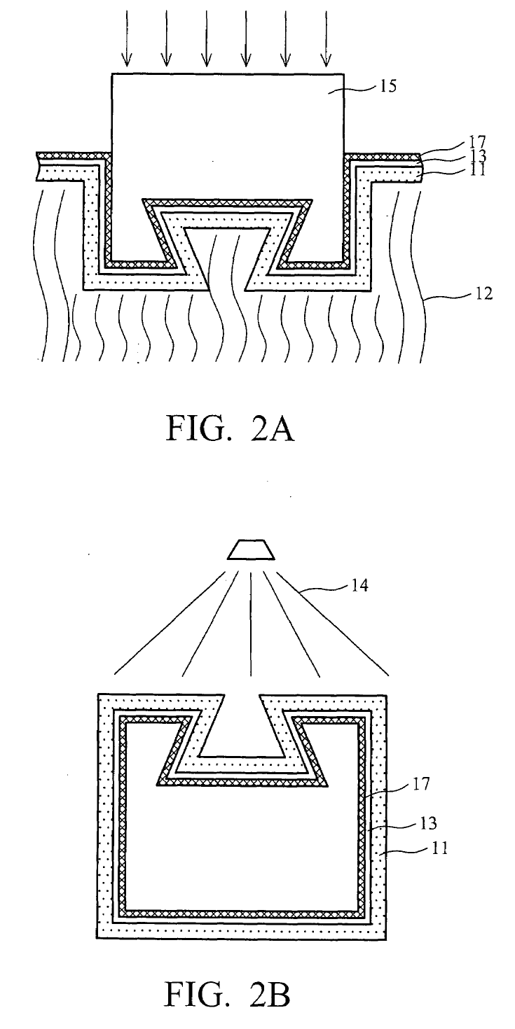

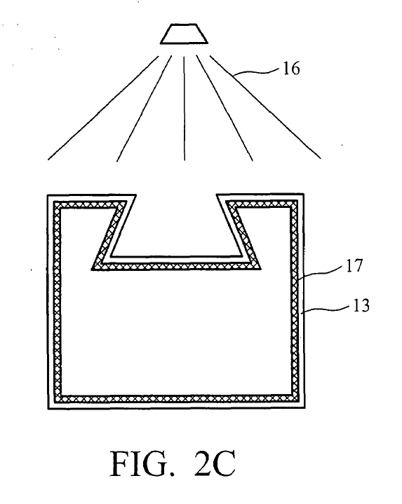

As shown in FIG. 2A, a water press transfer is processed with the water press transfer film in FIG. 1E. The activation step is the same as described previously, the active agent can be first coated onto the film to swell the decorating layer 17 and the protective layer 13. Another activation step is first placing the water press transfer film on the water and then coating the active agent on the film, such that the active agent, the decorating layer 17, and the protective layer 13 are evenly well swelled. Subsequently, the curved surface object 15 is placed on the water press transfer film and pressed into the water, such that the whole object 15 is wrapped by the water press transfer film by water pressure.

As shown in FIG. 2B, the object 15 is taken from the water, and its curved surface faces up. The curved surface of the object 15 is irradiated by a radiation 14 to initially cure the well swelled mixture of the active agent and the protective layer 13, such that the washing step of removing the carrier layer 13 will not damage the protective layer 13.

Finally, as shown in FIG. 2C, the well swelled mixture of the active agent and the protective layer 13 is further cured by thermal source 16 after washing out the carrier layer 11.

Although the water press transfer process is first cured by radiation and further cured by a thermal source as in FIGS. 2A-2C, the water press transfer process in the invention can also be first cured by thermal source and then cured by radiation.

Because the invention utilizes dual curable composition as the protective layer and the active agent, it has several advantages compared to conventional single photo curable composition. The indentation or the dead angle of curved surface objects and the parts shadowed by the opaque printing ink pattern cannot be irradiated by the radiation, but can be cured by a thermal source. Additionally, the lack of adherence between the photo curable composition and the objects surface material (e.g. steel or plastic) can be improved by introducing the thermal curable composition. In addition, generally, single thermal curable composition requires a longer curing period such as one hour. When compared to a single thermal curable composition, most steps of the dual curable composition in the invention are first cured by radiation in seconds, such that the period of the thermal curable step is significantly reduced.

### EXAMPLES AND COMPARATIVE EXAMPLES

### Example 1

45 parts by weight of resin PS330 (commercially available from En Chuan), 20 parts by weight of resin J678 (commercially available from Johnson), 18 parts by weight of oligomer 6161-100 (commercially available from Eternal), 11.5 parts by weight of oligomer 1010 (commercially available from Agisyn), 2 parts by weight of monomer trihydroxy methyl propane triacrylate (hereinafter TMPTA), 1 parts by weight of monomer 1,6-hexanediol diacrylate (hereinafter HDDA), 0.5 parts by weight of leveling agent 354 (commercially available from BYK), 1 parts by weight of photo initiator 1173 (commercially available from Darocur), and 1 parts by weight of thermal initiator 231 (commercially available from Lupersol) were dissolved in a co-solvent of toluene/isopropanol (8/2) to form a solution with a solid content of 40 wt %. The solution was then coated on a PVA film to form a protective layer with a thickness of 7 μm to 15 μm. The solvent of the protective layer was removed by dry baking at 50° C., such that a water press transfer film was formed.

5 parts by weight of resin E-7200 (commercially available from Dailic), 10 parts by weight of resin A 136-170 (commercially available from Dailic), 20 parts by weight of oligomer CN704 (commercially available from Satomers), 10 parts by weight of monomer HDDA, 40 parts by weight of monomer methyl methacrylate (hereinafter MMA), 10 parts by weight of monomer TMPTA, 1 parts by weight of photo initiator 1173 (commercially available from Darocur), and 1 parts by weight of thermal initiator 231 (commercially available from Lupersol), 3 parts by weight of leveling agent 354 (commercially available from BYK) were evenly mixed to form an active agent.

The active agent (usage amount is greater than 10 g/cm²) was coated on the protective layer. The water press transfer film was hot baked at 50° C. for 30 seconds, thereafter the water press transfer process was started. After transference to an acrylonitrile butadiene styrene (hereinafter ABS) object with a curved surface, the water press transfer film was initially cured by UV of 800-1200 mJ exposure energy and then washed to remove swelled PVA film. The properties of this initial cured protective layer are described as follows: cross hatch test was 100/100, surface gloss was 92, and thickness was 10-20 μm. The protective layer in the dead angled area of the curved object had a pencil hardness of about 1H to 2H, and the non-dead angled area had a pencil hardness of about 2H to 3H. After thermal treatment of 100° C. for 25 minutes, the protective layer had an average pencil hardness of 3H, for dead angled or non-dead angled areas.

### Example 2

50 parts by weight of resin PS330 (commercially available from En Chuan), 10 parts by weight of resin AC-4501C (commercially available from Dailic), 20 parts by weight of resin 1158 (commercially available from Cymel), 10 parts by weight of oligomer 6161-100 (commercially available from Eternal), 6 parts by weight of oligomer 1608 (commercially available from Ebercure), 2 parts by weight of monomer TMPTA, 1 parts by weight of monomer HDDA, 0.5 parts by weight of leveling agent 354 (commercially available from BYK), 1 parts by weight of photo initiator 1173 (commercially available from Darocur), and 1 parts by weight of thermal initiator 231 (commercially available from Lupersol) were dissolved in a co-solvent of toluene/isopropanol/ethyl acetate (6/2/2) to form a solution with a solid content of 40 wt %. The solution was then coated on a PVA film to form a protective layer with a thickness of 7 μm to 15 μm. The solvent of the protective layer was removed by dry baking at 50° C., such that a water press transfer film was formed.

The active agent of Example 1 (usage amount is greater than 10 g/cm²) was coated on the protective layer. The water press transfer film was hot baked at 50° C. for 30 seconds and thereafter the water press transfer process was started. After transference to a steel sheet object with a curved surface, the water press transfer film was initially cured by UV of 800-1200 mJ exposure energy and then washed to remove swelled PVA film. The properties of this initial cured protective layer are described as follows: cross hatch test was 100/100, surface gloss was 88, and thickness was 10-20 μm. The protective layer in the dead angled area of the curved object had a pencil hardness of about 1H to 2H, and the non-dead angled areas had a pencil hardness of about 2H to 3H. After thermal treatment at 160° C. for 20 minutes, the protective layer had an average pencil hardness of 3H, for dead angled or non-dead angled areas.

### Example 3

A printing ink pattern was printed on the protective layer of the water press transfer film as described in Example 1, obtaining a water press transfer film with a decorating layer. The decorating layer had a thickness of about 4-10 μm. The active agent of Example 1 (usage amount is greater than 10 g/cm²) was coated on the protective layer and the decorating layer. The water press transfer film was hot baked at 50° C. for 30 seconds and thereafter the water press transfer process was started. After transference to an ABS object with a curved surface, the water press transfer film was initially cured by UV of 800-1200 mJ exposure energy, washed to remove swelled PVA film, and further cured by thermal treatment at 80° C. for 10 minutes. The properties of this dual cured layer are described as follows: cross hatch test was 100/100, surface gloss was 89, and pencil hardness averaged 3H, for dead angled or non-dead angled areas.

### Example 4

An embossed surface relief hologram pattern on the protective layer of the water press transfer film as described in Example 1 was formed by evaporating aluminum, a obtaining a water press transfer film with a decorating layer. The decorating layer had a thickness of about 4-10 μm. The active agent of Example 1 (usage amount is greater than 10 g/cm²) was coated on the protective layer and the decorating layer. The water press transfer film was hot baked at 50° C. for 30 seconds and thereafter the water press transfer process was started. After transference to an ABS object with a curved surface, the water press transfer film was initially cured by UV of 800-1200 mJ exposure energy, washed to remove swelled PVA film, and further cured by thermal treatment at 80° C. for 10 minutes. The properties of this dual cured layer are described as follows: cross hatch test was 100/100, surface gloss was 89, and pencil hardness averaged 3H, for dead angled or non-dead angled areas.

### Comparative Example 1

The active agent of Example 1 (usage amount is greater than 10 g/cm²) was coated on the protective layer of the water press transfer film of Example 1. The water press transfer film was hot baked at 50° C. for 30 seconds and thereafter the water press transfer process was started. After transference to an ABS object with a curved surface, a little tag was attached on the object to form a local shadow. Subsequently, the water press transfer film was initially cured by UV of 800-1200 mJ exposure energy and washed to remove swelled PVA film. The properties of this cured protective layer are described as follows: cross hatch test was 100/100, surface gloss was 90, and pencil hardness was about 2H to 3H. The properties of the protective layer shadowed by the little tag are described as follows: cross hatch test was 100/100, but hardness and surface gloss were non-existent.

### Comparative Example 2

The active agent of Example 1 (usage amount is greater than 10 g/cm²) was coated on the protective layer of the water press transfer film of Example 1. The water press transfer film was hot baked at 50° C. for 30 seconds thereafter the water press transfer process was started. After transference to an ABS object with a curved surface, a little tag was attached on the object to form a local shadow. Subsequently, the water press transfer film was initially cured by UV of 800-1200 mJ exposure energy, washed to remove swelled PVA film but not the little tag, and further cured by thermal treatment at 80° C. for 10 minutes. Lastly, the remaining little tag and PVA film were removed. The properties of this dual cured protective layer are described as follows: cross hatch test was 100/100, surface gloss was 90, and pencil hardness averaged 2-3H, for shadowed or un-shadowed areas.

Table 1 shows the composition of the protective layer and the active agents, and the decorating layer structure for the Examples and Comparative Examples of the invention.

TABLE 1

| | | | | | |
|---|---|---|---|---|---|
| | | | | Comparative | Comparative |
| Example 1 | Example 2 | Example 3 | Example 4 | Example 1 | Example 2 |

Composition of protective layer

| | | | | | | |
|---|---|---|---|---|---|---|
| En Chuan PS330 | 45 | 50 | 45 | 45 | 45 | 45 |
| Johoson ® J678 | 20 | none | 20 | 20 | 20 | 20 |
| Dailic ® AC-4501C | none | 10 | none | none | none | none |
| Cymel ® 1158 | none | 20 | none | none | none | none |
| Eternal ® 6161-100 | 18 | 10 | 18 | 18 | 18 | 18 |
| AgiSyn ® 1010 | 11.5 | none | 11.5 | 11.5 | 11.5 | 11.5 |
| Ebercure ® 1608 | none | 6 | none | none | none | none |
| TMPTA | 2 | 2 | 2 | 2 | 2 | 2 |
| HDDA | 1 | 1 | 1 | 1 | 1 | 1 |
| BYK ® 354 | 0.5 | 0.5 | 0.5 | 0.5 | 0.5 | 0.5 |
| Darocur ® 1173 | 1 | 1 | 1 | 1 | 1 | 1 |
| Lupersol ® 231 | 1 | 1 | 1 | 1 | 1 | 1 |

Decorating layer structure

| | | | | | | |
|---|---|---|---|---|---|---|
| printing ink pattern | none | none | yes | none | none | none |
| embossed surface relief | none | none | none | yes | none | none |
| hologram pattern | | | | | | |

Active agent composition

| Dalic ® E-7200 | 5 | | | | | |
|---|---|---|---|---|---|---|
| Dalic ® A136-70 | 10 | | | | | |
| Satomers ® CN704 | 20 | | | | | |
| MMA | 40 | | | | | |
| HDDA | 10 | | | | | |
| TMPTA | 10 | | | | | |
| Darocur ® 1173 | 1 | | | | | |
| Lupersol ® 231 | 1 | | | | | |
| BYK ® 333 | 3 | | | | | |
| Carrier layer (PVA) | Tohcello 40μ | | | | | |
| Object material | ABS | Steel | ABS | ABS | ABS | ABS |
| | | sheet | | | | |

Note: printing ink pattern is commercially available from YHT printing, and the described ratios are all parts by weight.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A water pressure transfer film, comprising:
a carrier layer; and
a protective layer;
wherein the protective layer is a first radiation-thermal dual curable composition.

2. The film as claimed in claim 1, wherein the first radiation-thermal dual curable composition comprises a photo initiator, a thermal initiator, an oligomer, a monomer, and a membrane resin.

3. The film as claimed in claim 1, wherein the radiation comprises UV, electron beam, or combinations thereof.

4. The film as claimed in claim 1, wherein the thermal source comprises infrared radiation, hot air oven, or combinations thereof.

5. The film as claimed in claim 1, further comprising a decorating layer on the protective layer, wherein the decorating layer comprises a printing ink pattern, an embossed surface relief hologram pattern, or combinations thereof.

6. A water pressure transfer method, comprising:
providing an active agent to activate the film as claimed in claim 1, wherein the protective layer is well swelled by the active agent;
wherein the active agent is a second radiation-thermal dual curable composition;
wherein the activation step comprises coating the active agent to the film and then floating the film on the water, or floating the film on the water and then coating the active agent to the film;
placing an object on the film and pressing the object and the film into water, such that the film wraps the object;
getting the object out of water and providing radiation to cure the well-swelled mixture of the protective layer and the active agent;
washing out the carrier layer; and
providing a thermal source to further cure the well swelled mixture of the protective layer and the active agent.

7. The film as claimed in claim 6, wherein the first radiation-thermal dual curable composition comprises a photo initiator, a thermal initiator, an oligomer, a monomer, and a membrane resin.

8. The film as claimed in claim 6, wherein the second radiation-thermal dual curable composition comprises a photo initiator, a thermal initiator, an oligomer, a monomer, and a membrane resin.

9. The film as claimed in claim 6, wherein the radiation comprises UV, electron beam, or combinations thereof.

10. The film as claimed in claim 6, wherein the thermal source comprises infrared radiation, hot air oven, or combinations thereof.

11. A water pressure transfer method, comprising:
providing an active agent to activate the film as claimed in claim 1, wherein the protective layer is well swelled by the active agent;
wherein the active agent is a second radiation-thermal dual curable composition;
wherein the activation step comprises coating the active agent to the film and then floating the film on the water, or floating the film on the water and then coating the active agent to the film;
placing an object on the film and pressing the object and the film into water, such that the film wraps the object;
getting the object out of water and providing a thermal source to cure the well swelled mixture of the protective layer and the active agent;
washing out the carrier layer; and
providing a radiation to further cure the well swelled mixture of the protective layer and the active agent.

12. The film as claimed in claim 11, wherein the first radiation-thermal dual curable composition comprises a photo initiator, a thermal initiator, an oligomer, a monomer, and a membrane resin.

13. The film as claimed in claim 11, wherein the second radiation-thermal dual curable composition comprises a photo initiator, a thermal initiator, an oligomer, a monomer, and a membrane resin.

14. The film as claimed in claim 11, wherein the radiation comprises UV, electron beam, or combinations thereof.

15. The film as claimed in claim 11, wherein the thermal source comprises infrared radiation, hot air oven, or combinations thereof.
